(19) United States
(12) Patent Application Publication
(10) Pub. No.: US 2023/0300325 A1
(43) Pub. Date: Sep. 21, 2023

(54) VIDEO CODING METHOD AND APPARATUS USING INTRA PREDICTION

(71) Applicants: HYUNDAI MOTOR COMPANY, Seoul (KR); KIA CORPORATION, Seoul (KR); DIGITALINSIGHTS INC., Seoul (KR)

(72) Inventors: Yong Jo Ahn, Seoul (KR); Jong Seok Lee, Seoul (KR); Seung Wook Park, Yongin-si (KR)

(73) Assignees: HYUNDAI MOTOR COMPANY, Seoul (KR); KIA CORPORATION, Seoul (KR); DIGITALINSIGHTS INC., Seoul (KR)

(21) Appl. No.: 18/201,941

(22) Filed: May 25, 2023

Related U.S. Application Data
(63) Continuation of application No. PCT/KR2021/017965, filed on Dec. 1, 2021.

(30) Foreign Application Priority Data
Dec. 1, 2020 (KR) 10-2020-0165720
Dec. 1, 2021 (KR) 10-2021-0169663

(51) Int. Cl. H04N 19/105; H04N 19/11; H04N 19/176; H04N 19/159

(52) U.S. Cl. CPC H04N 19/105; H04N 19/11; H04N 19/176; H04N 19/159

(57) ABSTRACT

The present disclosure is related to a video encoding/decoding method and an apparatus using an intra prediction. The video encoding/decoding method and apparatus generate a predictor by performing a direction-based prediction and generate a predictor by performing a rule-based (or matrix operation-based) prediction. The video encoding/decoding method and apparatus combine the two predictors to generate a final intra predictor of the current block.

### CROSS-REFERENCE TO RELATED APPLICATIONS

This application is a Continuation of International Application No. PCT/KR2021/017965 filed on Dec. 1, 2021, which claims priority to Korean Patent Application No. 10-2020-0165720 filed on Dec. 1, 2020, and Korean Patent Application No. 10-2021-0169663 filed on Dec. 1, 2021, the entire disclosures of which are incorporated herein by reference.

### TECHNICAL FIELD

The present disclosure relates to a method and an apparatus for video coding by using an intra prediction.

### BACKGROUND

The statements in this section merely provide background information related to the present disclosure and do not necessarily constitute prior art.

Since video data has a large amount of data compared to audio or still image data, the video data requires a lot of hardware resources, including memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/AVC, High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

In the image (video) encoding and decoding, an intra prediction method may be performed to predict the current block by using pixels in the same frame. In this case, intra prediction methods can be categorized into two main types based on how to generate predicted samples.

The first type of the intra prediction method is a traditional intra prediction method. The traditional intra prediction method is a direction-based prediction that performs a prediction based on the prediction direction of the pixels and the neighboring pixels that are spatially adjacent to the target block for intra prediction. A direction-based prediction has the advantage of being simple to implement, but the direction-based prediction suffers from decreased prediction performance when a pattern exists in the target block or when an object exists in the bottom right of the target block.

The second type of the intra prediction method is a rule-based prediction method. The rule-based prediction method utilizes the coding information of the target block for intra prediction and the neighboring pixels that are spatially adjacent to the target block. Thus, the rule-based prediction method performs either a predefined operation or the prediction operation with a predefined matrix. While the rule-based prediction can compensate for the shortcomings of direction-based predictions, it is relatively complex to implement the rule-based prediction, and the rule-based prediction suffers from poor prediction performance for target blocks that do not conform to the rules.

Therefore, in terms of improving image quality, there is a need for an intra prediction method that can combine the advantages of direction-based prediction and rule-based prediction.

### SUMMARY

The present disclosure in some embodiments seeks to provide a video encoding/decoding method and an apparatus that, in performing an intra prediction, generate a predictor by performing a direction-based prediction and generate a predictor by performing a rule-based (or matrix operation-based) prediction. The video encoding/decoding method and apparatus combine the two predictors to generate a final intra predictor of the current block.

At least one aspect of the present disclosure provides an intra prediction method performed by a video decoding apparatus. The method includes decoding, from a bitstream, a combined intra prediction flag that indicates enablement of combining between a direction-based intra prediction and a matrix operation-based intra prediction. The method also includes performing an intra prediction of the current block according to the combined intra prediction flag. When the combined intra prediction flag is true, the method includes: performing the intra prediction comprises decoding, from the bitstream, a direction-based intra prediction mode of the current block; generating a first intra predictor of the current block by using the direction-based intra prediction mode; decoding, from the bitstream, an index indicating one of a plurality of predefined matrices utilized in the matrix operation-based intra prediction; generating a second intra predictor of the current block by using a predefined matrix indicated by the index; and generating a combined intra predictor of the current block by combining the first intra predictor and the second intra predictor.

Another aspect of the present disclosure provides a video decoding apparatus for generating a combined intra predictor of a current block. The video decoding apparatus includes an entropy decoder configured to decode, from a bitstream, a combined intra prediction flag that indicates enablement of combining between a direction-based intra prediction and a matrix operation-based intra prediction. The video decoding apparatus also includes an intra predictor configured to perform an intra prediction of the current block according to the combined intra prediction flag. When the combined intra prediction flag is true, the entropy decoder is configured to decode, from the bitstream, a direction-based intra prediction mode of the current block, and an index indicating one of a plurality of predefined matrices utilized in the matrix operation-based intra prediction. When the combined intra prediction flag is true, the intra predictor is configured to generate a first intra predictor of the current block by using the direction-based intra prediction mode, to generate a second intra predictor of the current block by using a predefined matrix indicated by the index, and to generate a combined intra predictor of the current block by combining the first intra predictor and the second intra predictor.

Yet another aspect of the present disclosure provides a intra prediction method performed by a video encoding apparatus. The method includes obtaining a combined intra prediction flag that indicates enablement of combining between a direction-based intra prediction and a matrix operation-based intra prediction. The method also includes performing an intra prediction of the current block according to the combined intra prediction flag. When the combined intra prediction flag is true, the method includes: performing the intra prediction comprises obtaining a direction-based intra prediction mode of the current block; generating a first intra predictor of the current block by using the direction-based intra prediction mode; obtaining an index indicating one of a plurality of predefined matrices utilized in the matrix operation-based intra prediction; generating a second intra predictor of the current block by using a predefined matrix indicated by the index; and generating a combined intra predictor of the current block by combining the first intra predictor and the second intra predictor.

As described above, the present embodiment provides a video image encoding/decoding method and an apparatus that generate a predictor by performing a direction-based prediction and generate a predictor by performing a rule-based (or matrix operation-based) prediction. The video encoding/decoding method and apparatus combine the two predictors to generate a final intra predictor of the current block, to improve the video quality based on the intra prediction.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating pixels that are spatially adjacent to pixels in the current block, according to at least one embodiment of the present disclosure.

FIG. 7 is a diagram illustrating a rule-based intra prediction according to at least one embodiment of the present disclosure.

FIG. 8 is a diagram illustrating a rule-based intra prediction according to another embodiment of the present disclosure.

FIG. 9 is a diagram illustrating an intra predictor performing a combined intra-prediction, according to at least one embodiment of the present disclosure.

FIG. 10 is a diagram illustrating a combined intra predictor for the current block, according to at least one embodiment of the present disclosure.

FIG. 11 is a diagram illustrating a current block and its spatially adjacent neighboring blocks, according to at least one embodiment of the present disclosure.

FIG. 12 is a flowchart of a method performed by a video decoding apparatus for generating a combined intra predictor, according to at least one embodiment of the present disclosure.

FIG. 13 is a flowchart of a method performed by a video decoding apparatus for generating a combined intra predictor, according to another embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

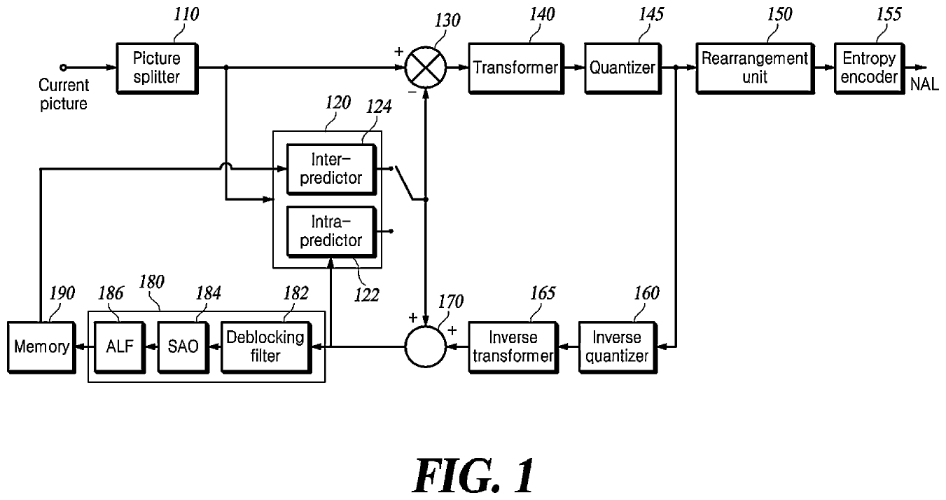

FIG. 1 is a block diagram of a video encoding apparatus that may implement technologies of the present disclosure. Hereinafter, referring to illustration of FIG. 1, the video encoding apparatus and sub-components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each CU is encoded as a syntax of the CU and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of CTU. Information on the size of the CTU (CTU size) is encoded as the syntax of the SPS or the PPS and delivered to a video decoding apparatus.

The picture splitter 110 splits each picture constituting the video into a plurality of CTUs having a predetermined size and then recursively splits the CTU by using a tree structure. A leaf node in the tree structure becomes the CU, which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a BTTT is added to the tree structures to be referred to as a multiple-type tree (MTT).

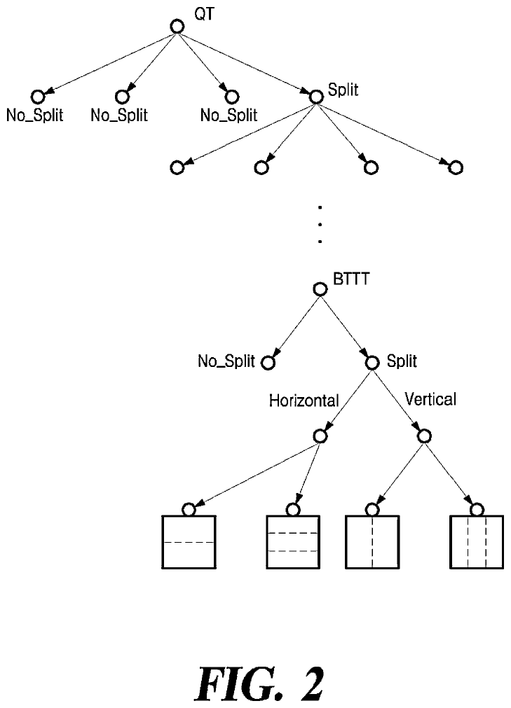

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks of a form of being asymmetrical to each other may be additionally present. The asymmetrical form may include a form in which the block of the corresponding node split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block”. As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

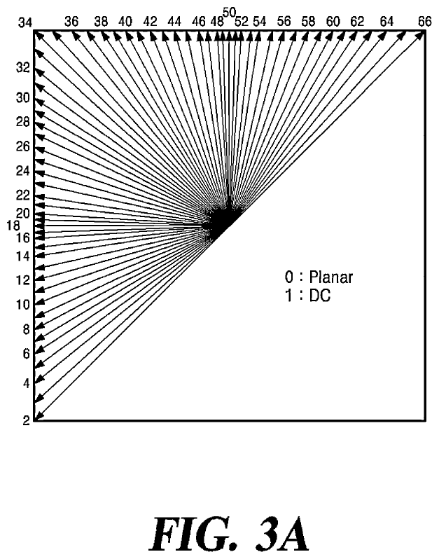

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having the rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and also select an appropriate intra prediction mode to be used from tested modes. For example, the intra predictor 122 may calculate rate-distortion values by using a rate-distortion analysis for multiple tested intra prediction modes and also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current bock in the current picture and the prediction block in the reference picture. In general, motion estimation is performed for a luma component, and a motion vector calculated based on the luma component is used for both the luma component and a chroma component.

Motion information including information the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, etc. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of the bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and information on two motion vectors is delivered to the entropy encoder 155. Here, reference picture list 0 may be constituted by pictures before the current picture in a display order among pre-restored pictures, and reference picture list 1 may be constituted by pictures after the current picture in the display order among the pre-restored pictures. However, although not particularly limited thereto, the pre-restored pictures after the current picture in the display order may be additionally included in reference picture list 0. Inversely, the pre-restored pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

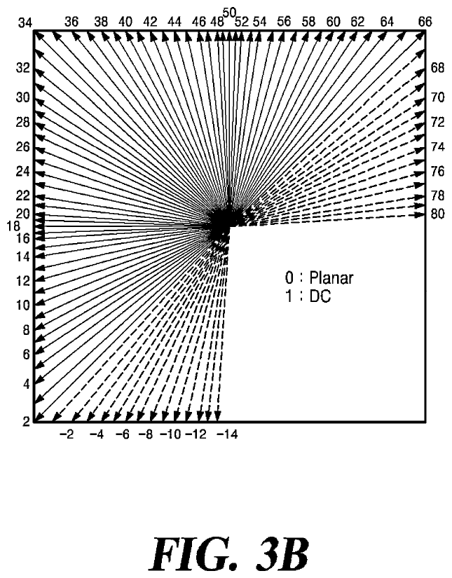

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

The merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, etc.) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and transform the residual block in each of the horizontal and vertical directions. Information (mts_jdx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to transform coefficients quantized arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to restore the residual block.

The adder 170 adds the restored residual block and the prediction block generated by the predictor 120 to restore the current block. Pixels in the restored current block may be used as reference pixels when intra-predicting a next-order block.

The loop filter unit 180 performs filtering for the restored pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the restored blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the restored pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The restored block filtered through the deblocking filter 182, the SAO filter 184, and the ALF 186 is stored in the memory 190. When all blocks in one picture are restored, the restored picture may be used as a reference picture for inter predicting a block within a picture to be encoded afterwards.

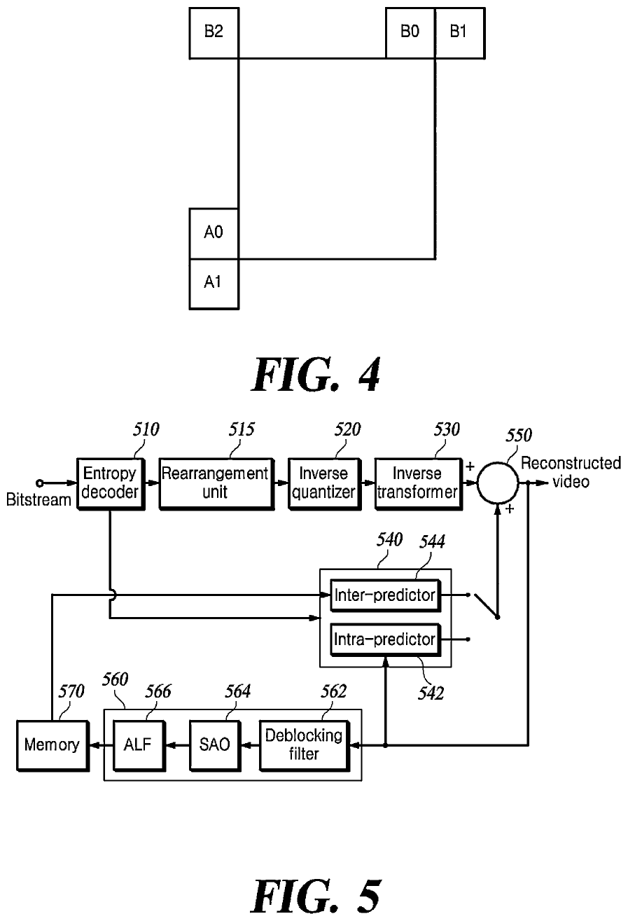

FIG. 5 is a functional block diagram of a video decoding apparatus that may implement the technologies of the present disclosure. Hereinafter, referring to FIG. 5, the video decoding apparatus and sub-components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for restoring the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT being further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information, and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by restoring the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to restore the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include the intra predictor 542 and the inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 restores the current block by adding the residual block output from the inverse transformer 530 and the prediction block output from the inter predictor 544 or the intra predictor 542. Pixels within the restored current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the restored blocks in order to remove the blocking artifact, which occurs due to block unit decoding. The SAO filter 564 and the ALF 566 perform additional filtering for the restored block after the deblocking filtering in order to compensate differences between the restored pixels and original pixels, which occur due to lossy coding. The filter coefficients of the ALF are determined by using information on filter coefficients decoded from the bitstream.

The restored block filtered through the deblocking filter 562, the SAO filter 564, and the ALF 566 is stored in the memory 570. When all blocks in one picture are restored, the restored picture may be used as a reference picture for inter predicting a block within a picture to be encoded afterwards.

The present embodiment relates to encoding and decoding of an image (video) described above. More specifically, the present embodiment provides a video encoding/decoding method and an apparatus that, in performing an intra prediction, generate a predictor by performing a direction-based prediction and generate a predictor by performing a rule-based (or matrix operation-based) prediction. The video encoding/decoding method and apparatus combine the two predictors to generate a final intra predictor of the current block.

In the following description, the term “target block” may be used interchangeably with the current block or coding unit (CU) as described above or may refer to a portion of a coding unit.

Meanwhile, the following embodiments may be carried out in the intra predictor 122 of the video encoding apparatus and the intra predictor 542 of the video decoding apparatus. Hereinafter, to avoid redundancy, the embodiments are described from the perspective of the intra predictor 542 in the video decoding apparatus.

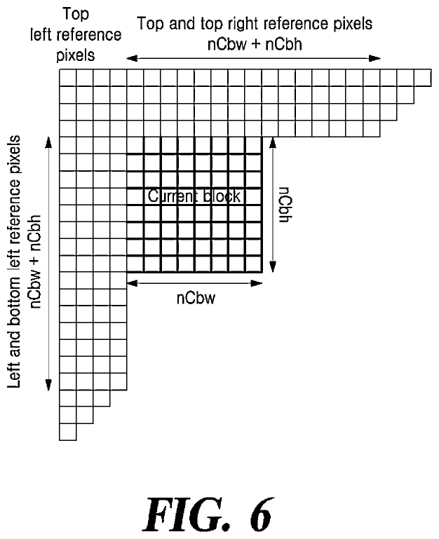

FIG. 6 is a diagram illustrating pixels that are spatially adjacent to pixels in the current block, according to at least one embodiment of the present disclosure.

The intra predictor 542 in the video decoding apparatus generates an intra predictor corresponding to the current block by using multiple neighboring pixels spatially adjacent to the current block and particular directions, as illustrated in FIG. 6. Here, the predictor represents a combination of certain decoded values. Thus, an intra predictor represents a combination of predicted samples, or a prediction block, which corresponds to the result of the intra prediction. Hereinafter, predictor, predicted samples, and prediction block may be used interchangeably.

Among a plurality of neighboring pixels spatially adjacent to the current block, the neighboring pixels utilized in the intra prediction may differ in number depending on the direction used in the intra prediction. As illustrated in FIG. 6, the current block's width is assumed to be nCbw, and the current blocks height is assumed to be nCbh. In this case, the reference pixels for intra prediction may include reference pixels at the top left position of the block, reference pixels disposed at the top and top right positions of the block and being equal in number to the sum of the width of the block and the height of the block, and reference pixels disposed at the left and bottom left positions of the block and being equal in number to the sum of the width of the block and the height of the block.

In performing the intra prediction, as illustrated in FIG. 6, the intra predictor 542 may refer to but is not necessarily limited to pixels on one sample line as the referable neighboring pixels. For example, the intra predictor 542 may use, as the referable neighboring pixels, those pixels that are spatially located at different pixel distances from the current block.

Furthermore, the intra predictor 542 may use but is not necessarily limited to using one pixel line of the plurality of pixel lines as a reference pixel line. For example, the intra predictor 542 may generate a predictor by using reference pixel lines that are combinations of the plurality of pixel lines.

### I. Direction-based Intra Prediction

As illustrated in FIG. 3A, the direction for intra prediction may be evenly divided into units of reference angles to have a particular inner angle. Alternatively, some unevenly divided directions may be used depending on the characteristics of the current block.

Further, the available directions for intra prediction may change based on the shape of the block. In this case, the shape of the block may refer to particular information derived from the ratio between the width and height of the block, the relative length comparison between the width and height, and the like. Further, the available directions based on the shape of the block may be the directions represented by the wide-angle intra-prediction modes added to the illustration of FIG. 3B for the illustration of FIG. 3A.

### II. Example Rule-Based Intra Prediction

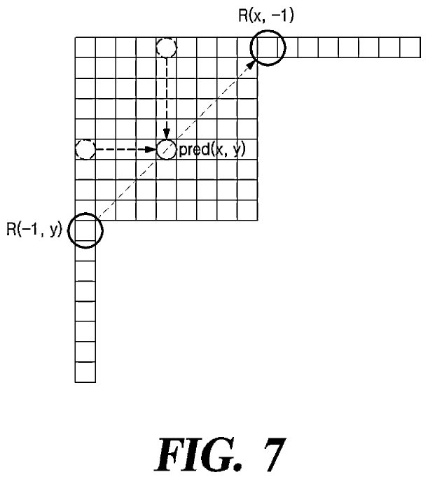

FIG. 7 is a diagram illustrating a rule-based intra prediction according to at least one embodiment of the present disclosure.

Utilizing the encoded information of the target block to be intra predicted and the spatially adjacent neighboring pixels of the target block, a predictor may be generated based on a predefined operation. One such rule-based prediction method is the Position Dependent intra Prediction Combination (PDPC), as illustrated in FIG. 7.

PDPC modifies predicted samples generated according to a particular intra prediction mode to generate an intra predictor of the current block. The particular intra prediction mode includes, among the prediction modes exemplified in FIG. 3A, Planar, DC, horizontal (prediction mode 18), vertical (prediction mode 50), a left-downward diagonal directional mode (prediction mode 2) and 15 directional modes proximate thereto, and a right-upward diagonal directional mode (prediction mode 66) and 15 directional modes proximate thereto.

As illustrated by FIG. 7, for the current block's predicted samples generated according to a particular intra prediction mode, the PDPC may use predefined weights and position information of neighboring pixels and thus generate the predicted samples with their values adjusted at pixel level. The PDPC may generate the adjusted predicted samples according to Equation 1.

P(x,y)=(wL·R_{-1·y}+wT·R_{x·-1}+(64−wL−wT)·P(x,y)+32)>>6 Equation 1

Where P(x,y) on the left-hand side represents predicted samples generated by a particular intra prediction mode, and P(x,y) on the right-hand side represents predicted samples adjusted according to Equation 1. wL and wT are the predefined weights, which can be set differently depending on the particular intra prediction mode. Additionally, R_{x·-1} represents a reference pixel located at the top of the current block, and R_{-1·y} represents a reference pixel located at the left of the current block.

The foregoing represents but is not necessarily limited to an example of PDPC applied according to a particular intra prediction mode. In another embodiment, to indicate whether such PDPC is enabled, the video encoding apparatus may encode a position-dependent prediction flag and transmit the position-dependent prediction flag to the video decoding apparatus.

### III. Other Example Rule-based Intra Predictions

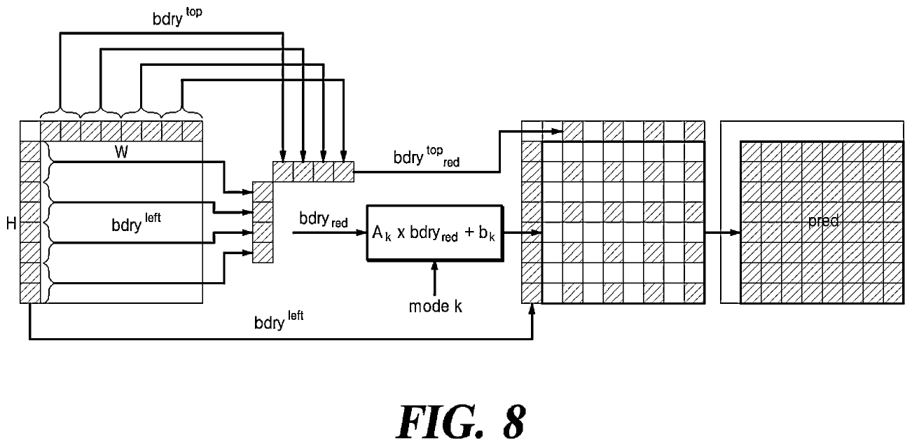

FIG. 8 is a diagram illustrating a rule-based intra prediction according to another embodiment of the present disclosure.

By using the neighboring pixels of the current block for which intra prediction is being performed and the encoding information of the current block, predictors may be generated based on a predefined matrix's operation, as illustrated in FIG. 8. This rule-based prediction method is referred to as Matrix weighted Intra Prediction (MIP).

MIP generates the intra predictor in whole or in part by using the predefined matrix's operation. When the predictor is generated in part, the MIP may further perform upsampling or interpolation for upscaling by using the predictor in part and thereby generate final intra predicted samples equal to the size of the current block.

Meanwhile, the MIP may selectively choose some of the pixels that are spatially adjacent to the current block and use some selected pixels as neighboring pixels of the current block. In another embodiment, the MIP may use for matrix operations such values as derived based on operations based on subsampling, downscaling, or the like.

FIG. 8 illustrates using the values derived based on operations and a matrix of a smaller size than the current block, thereby generating the current block's predictor in part. Hereinafter, embodiments of the MIP are described using the illustration of FIG. 8.

First, a certain number of samples are generated from the boundary samples of the current block by using an averaging operation. For example, the certain number of samples generated from boundary samples bdry^{top} on the top and boundary samples bdry^{left} on the left with a predefined rule used based on the block size are their reduced boundary samples bdry^{top}_{red} and bdry^{left}_{red}. Further, the reduced boundary samples bdry^{top}_{red} and bdry^{left}_{red} under the predefined rule are combined to generate a reduced boundary vector bdry_{red}.

Then, with the predefined matrix's operation applied to the reduced boundary vector bdry_{red}, a reduced predictor pred_{red} is generated for a portion of the current block, as illustrated in FIG. 8. Here, pred_{red} is a block whose size is downsampled from the current block, having a width W_{red} and a height H_{red}. The width W_{red} and height H_{red} may be determined based on the block's size. The reduced predictor pred_{red} may be calculated according to Equation 2.

pred_{red}=Aₖ·bdry_{red}+bₖ Equation 2

Where Aₖ is a predefined matrix with rows as many as W_{red}·H_{red} and columns of the same dimension as bdry_{red}. Meanwhile, bₖ is a predefined vector with a size of W_{red}·H_{red} dimensions. The subscript k in Aₖ and bₖ is an index indicating one of the predefined matrices and vectors.

Finally, a linear interpolation is applied to the reduced predictor pred_{red} to generate predicted samples for the remaining locations in the current block. This linear interpolation is performed first in the horizontal direction and then in the vertical direction, regardless of the size and shape of the block.

To indicate whether or not to activate these MIPs, the video encoding apparatus may encode and transmit a matrix-based prediction flag to the video decoding apparatus. Additionally, the video encoding apparatus may encode and transmit to the video decoding apparatus an index indicative of one of the predefined matrices and one of the predefined vectors.

### IV. Improved Intra Prediction

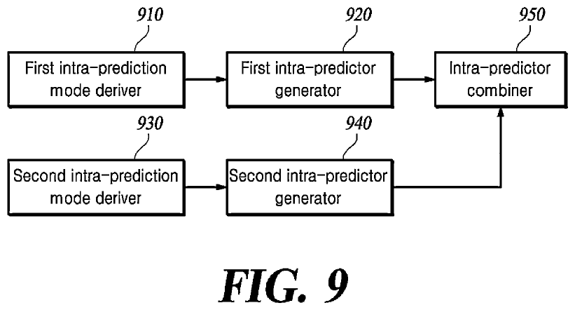

FIG. 9 is a diagram illustrating an intra predictor performing combined intra-prediction, according to at least one embodiment of the present disclosure.

The intra predictor 542 according to this embodiment combines, for the current block, a predictor generated by performing a direction-based prediction and a predictor generated by performing a matrix operation-based prediction corresponding to a rule-based prediction. The intra predictor 542 includes a first intra-prediction mode deriver 910, a first intra-predictor generator 920, a second intra-prediction mode deriver 930, a second intra-predictor generator 940, and an intra-predictor combiner 950 in whole or in part.

The first intra-prediction mode deriver 910 derives a first intra prediction mode. Here, the first intra prediction mode may be one of an intra prediction mode based on a direction-based prediction, as illustrated in FIG. 3A. By decoding the intra prediction mode transmitted from the video encoding apparatus by using the entropy decoder 510 in the video decoding apparatus, the first intra-prediction mode deriver 910 may derive the first intra prediction mode.

The first intra-predictor generator 920 may use the first intra prediction mode to generate the first intra predictor of the current block. For example, by using a decoded direction-based intra prediction mode, the first intra-predictor generator 920 may generate predicted samples from neighboring pixels of the current block.

The second intra-prediction mode deriver 930 derives a second intra prediction mode. Here, the second intra prediction mode may be one of the rule-based intra prediction modes, as illustrated in FIGS. 7 and 8.

After decoding the matrix-based prediction flag transmitted from the video encoding apparatus by using the entropy decoder 510, the second intra-prediction mode deriver 930 may confirm that the matrix-based prediction flag is true and thereby derive the second intra prediction mode, which is a matrix operation-based intra prediction mode.

In another embodiment, with the entropy decoder 510 decoding a predefined matrix's index transmitted from the video encoding apparatus, the second intra-prediction mode deriver 930 may derive a second intra prediction mode, which is a matrix operation-based intra prediction mode. In this case, the index indicates one of a plurality of predefined matrices and one of a plurality of predefined vectors utilized in the matrix operation-based prediction.

In yet another embodiment, after decoding the position-dependent prediction flag transmitted from the video encoding apparatus by using the entropy decoder 510, and by confirming that the position-dependent prediction flag is true, the second intra-prediction mode deriver 930 may derive the second intra prediction mode, which is a rule-based intra prediction mode.

The second intra-predictor generator 940 may generate a second intra predictor of the current block by using the second intra prediction mode. For example, when the matrix-based prediction flag is true, the second intra-predictor generator 940 may generate predicted samples from neighboring pixels of the current block by using a predefined matrix A and a predefined vector b, as illustrated in FIG. 8.

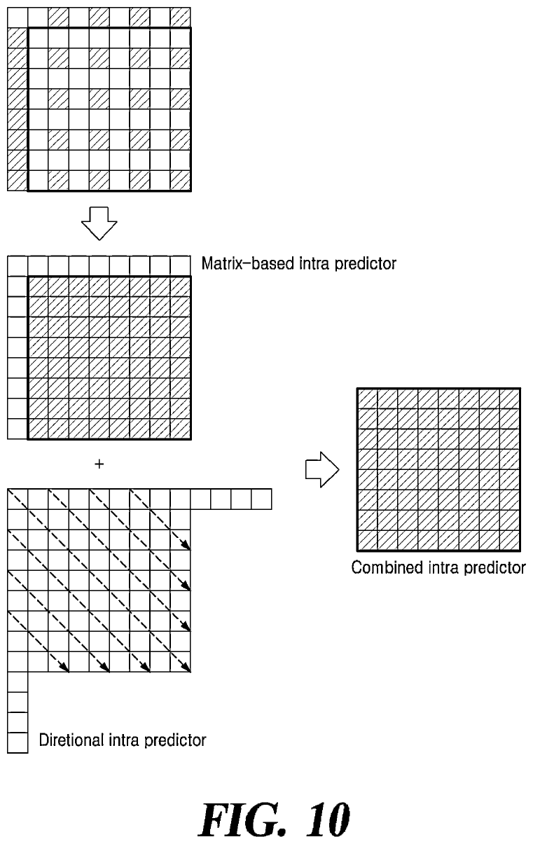

The intra-predictor combiner 950, as illustrated in FIG. 10, combines the first intra predictor and the second intra predictor to generate a combined intra predictor of the current block.

After decoding the combined intra predictor flag transmitted from the video encoding apparatus by using the entropy decoder 510, when the combined intra predictor flag is true, the intra-predictor combiner 950 may generate the combined intra predictor. In this case, the combined intra predictor flag indicates whether the combined intra prediction is enabled.

When combining the first intra predictor based on the direction-based prediction and the second intra predictor based on the matrix operation-based prediction, the intra-predictor combiner 950 may utilize an average or weighted average per the same pixel position for both predictors. Here, the average refers to the average of pixel s1 corresponding to the first intra predictor for the same pixel location and pixel s2 corresponding to the second intra predictor for the same pixel location. The weighted average represents the weighted sum of pixel s1 and pixel s2 by applying different weight pairs to them. Examples of different weight pairs may be but are not necessarily limited to {¼, ¾}, {⅛, ⅞}, {−¼, 5/4}, {−⅛, 9/8}, and the like. Another example may utilize a weight pair wherein the sum of both weights is 1 and the denominator of each weight is a power of 2.

In combining the first intra predictor based on the direction-based prediction and the second intra predictor based on the matrix operation-based prediction, the intra-predictor combiner 950 according to this embodiment may generate the combined intra predictor by using the same weight as described above.

In another embodiment of the present disclosure, the intra-predictor combiner 950 may refer to the prediction mode of the current block and the neighboring blocks and thereby calculate a different weight for each of the first intra predictor and the second intra predictor. In the combining of the first intra predictor and the second intra predictor, the intra-predictor combiner 950 may apply the weights calculated based on the prediction mode information of the previously decoded neighboring blocks to generate a combined intra predictor.

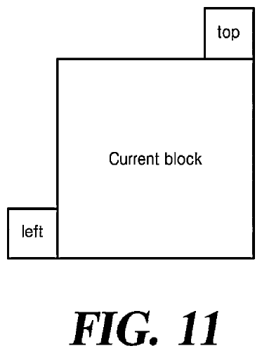

FIG. 11 is a diagram illustrating a current block and its spatially adjacent neighboring blocks, according to at least one embodiment of the present disclosure.

The neighboring blocks refer to one or more previously decoded blocks spatially adjacent to the current block, which may be but are not necessarily limited to a left block adjacent to the left of the current block and a top block adjacent to the top of the current block, as illustrated in FIG. 11. Accordingly, the present disclosure may include embodiments that include additional locations of the neighboring blocks to the examples in FIG. 11.

As described above, to utilize the prediction mode information of the neighboring blocks, the intra predictor 542 may obtain the prediction modes of the blocks corresponding to the left block and the top block positions of the current block.

Here, the prediction modes of the left block and the top block of the current block may be one of a direction-based intra prediction mode and a matrix operation-based intra prediction mode. Further, the prediction mode of the left block and the top block may be a combined intra prediction mode. A combined intra prediction mode represents an intra prediction mode that is obtained by combining a direction-based prediction and a matrix operation-based prediction.

Additionally, the prediction modes of the left and top blocks may represent intra prediction modes or inter prediction modes.

In at least one embodiment of the present disclosure, when the intra-prediction modes of the left block and the top block are both direction-based prediction modes, the intra-predictor combiner 950 may set the weight of the first intra predictor according to the direction-based prediction to a value greater than the weight of the second intra predictor according to the matrix operation-based prediction. For example, the intra-predictor combiner 950 may set the weight of the first intra predictor to ¾ and the weight of the second intra predictor to ¼ and then apply these weights to the first intra predictor and the second intra predictor to generate a combined intra predictor.

In another embodiment, when only one of the intra-prediction modes of the left block and the top block is a directional prediction mode, i.e., the prediction mode of one of the two blocks is a direction-based intra-prediction mode and the prediction mode of the other block is a matrix operation-based intra-prediction mode, the intra-predictor combiner 950 may set the weights of the first intra predictor and the second intra predictor to the same value. For example, the intra-predictor combiner 950 may set the weight of the first intra predictor to ½ and the weight of the second intra predictor to ½ and then apply these weights to the first intra predictor and the second intra predictor to generate a combined intra predictor.

In yet another embodiment, when the intra-prediction modes of the left block and the top block are both matrix operation-based prediction modes, the intra-predictor combiner 950 may set the weight of the second intra predictor according to the matrix operation-based prediction to a value greater than the weight of the first intra predictor according to the direction-based prediction. For example, the intra-predictor combiner 950 may set the weight of the first intra predictor to ¼ and the weight of the second intra predictor to ¾ and then apply these weights to the first intra predictor and the second intra predictor to generate a combined intra predictor.

On the other hand, the intra-predictor combiner 950 may vary the process of setting weights for generating intra predictors from intra-prediction modes of neighboring blocks depending on the slice type. For example, when the current slice type is an intra or I slice, the prediction modes of the neighboring blocks are all intra prediction modes. Whereas, the current slice type may be a predictive or P slice or a bipredictive or B slice, wherein intra prediction and inter prediction coexist. In this case, the intra-predictor combiner 950 may apply a different process for setting weights to a P slice or a B slice from the process for setting weights in an I slice.

What is described above may also be performed in the intra predictor 122 of the video encoding apparatus. The video encoding apparatus, in terms of optimizing the rate distortion, searches for a direction-based intra prediction mode, sets predefined matrix's index and sets a matrix-based prediction flag and a combined intra prediction flag. Thus, the intra predictor 122 may derive the first intra prediction mode by obtaining the direction-based intra prediction mode.

After obtaining the matrix-based prediction flag, the intra predictor 122 may induce the second intra prediction mode by confirming that the matrix-based prediction flag is true. In another embodiment, the intra predictor 122 may derive the second intra prediction mode by obtaining a predefined matrix's index. In this case, the index indicates one of a plurality of predefined matrices and one of a plurality of predefined vectors utilized in the matrix operation-based prediction.

After obtaining the combined intra prediction flag, when the combined intra prediction flag is true, the intra predictor 122 may combine the first intra predictor and the second intra predictor to generate the combined intra predictor of the current block.

The video encoding apparatus may encode the optimized direction-based intra prediction mode, the matrix-based prediction flag, the predefined matrix's index, and the combined intra prediction flag and transmit them to the video decoding apparatus.

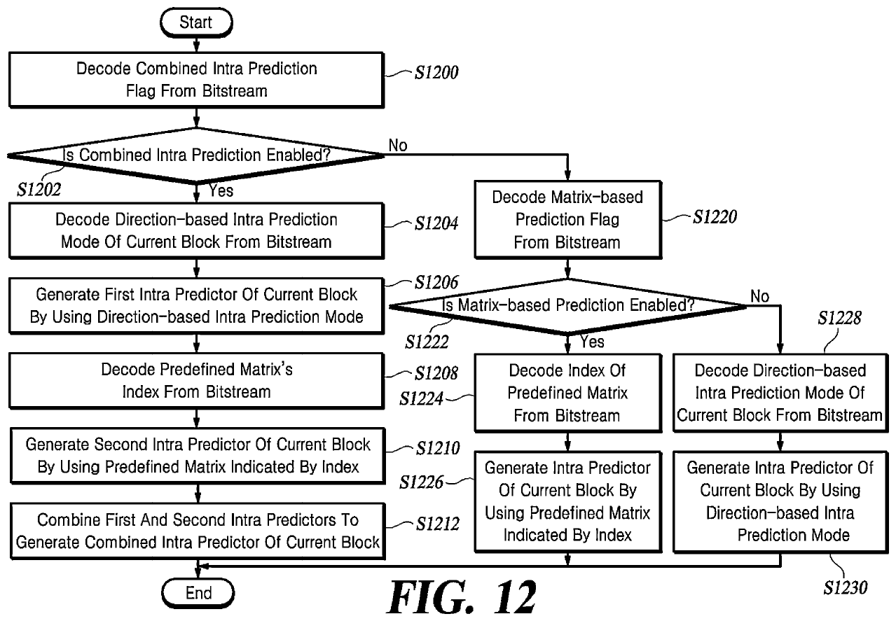

The following uses the example of FIG. 12 to describe a method performed by the video decoding apparatus when the combined intra predictor flag is first decoded, for generating a combined intra predictor of the current block. Here, the combined intra predictor flag indicates whether to enable the combining between the direction-based intra predictor and the matrix operation-based intra predictor.

FIG. 12 is a flowchart of a method performed by a video decoding apparatus for generating a combined intra predictor, according to at least one embodiment of the present disclosure.

The entropy decoder 510 in the video decoding apparatus decodes the combined intra prediction flag from the bitstream (S1200).

The intra predictor 542 in the video decoding apparatus checks the combined intra prediction flag to determine whether the combined intra prediction is enabled (S1202).

When the combined intra prediction flag is true, and the combined intra prediction is enabled (Yes in S1202), the video decoding apparatus performs the following steps (Steps S1204 to S1212).

The entropy decoder 510 decodes the direction-based intra prediction mode of the current block from the bitstream (S1204). By decoding the direction-based intra prediction mode, the direction-based prediction may be set as the intra prediction mode of the current block.

The intra predictor 542 generates a first intra predictor of the current block by using the direction-based intra prediction mode (S1206).

The entropy decoder 510 decodes a predefined matrix's index from the bitstream (S1208). By decoding the index indicating one of a plurality of predefined matrices utilized in the matrix operation-based prediction, the matrix operation-based prediction, which is one of the rule-based prediction methods, may be set as the intra prediction mode of the current block.

The intra predictor 542 generates a second intra predictor of the current block by using the predefined matrix indicated by the index (S1210).

The foregoing illustrates but is not necessarily limited to a case where matrix computation-based prediction is utilized to generate the second intra predictor of the current block. In other embodiments, other rule-based prediction methods, such as PDPC, may be utilized to generate the second intra predictor of the current block. For example, the video decoding apparatus may decode the position-dependent prediction flag and, if the position-dependent prediction flag is true, use the position-dependent prediction to generate the second intra predictor. Here, the position-dependent prediction flag indicates whether the position-dependent prediction is enabled.

The intra predictor 542 may generate the second intra predictor before the first intra predictor. Alternatively, the intra predictor 542 may generate the first intra predictor and the second intra predictor in parallel.

The intra predictor 542 combines the first intra predictor and the second intra predictor to generate a combined intra predictor of the current block (S1212).

When combining the first intra predictor based on the direction-based prediction with the second intra predictor based on the matrix operation-based prediction, the intra predictor 542 may utilize an average or weighted average per the same pixel position for the two predictors.

Here, the average represents an average of the pixels corresponding to the first intra predictor and the pixels corresponding to the second intra predictor for the same pixel location. The weighted average represents a weighted sum of the pixels corresponding to the first intra predictor after applying a certain weight pair and the pixels corresponding to the second intra predictor after applying different weight pairs. Examples of different weight pairs may be but are not necessarily limited to {¼, ¾}, {⅛, ⅞}, {−¼, 5/4}, {−⅛, 9/8}, etc. As another example, a pair of weights may be utilized where the sum of the two weights is 1 and the denominator of each weight is a power of 2.

On the other hand, when the combined intra prediction flag is false, meaning that combined intra prediction is not enabled (No in S1202), the video decoding apparatus performs the following steps (Steps S1220 to S1230).

The entropy decoder 510 decodes a matrix-based prediction flag from the bitstream (S1220). Here, the matrix-based prediction flag indicates whether the matrix operation-based prediction is enabled or disabled.

The intra predictor 542 checks the matrix-based prediction flag to determine whether matrix-based prediction is enabled (S1222).

When the matrix-based prediction flag is true and matrix-based prediction is enabled (Yes in S1222), the entropy decoder 510 decodes the predefined matrix's index from the bitstream (S1224), and the intra predictor 542 uses the predefined matrix indicated by the index to generate the intra predictor of the current block (S1226).

On the other hand, when the matrix-based prediction flag is false, meaning that matrix-based prediction is not enabled (No in S1222), the entropy decoder 510 decodes the direction-based intra prediction mode of the current block from the bitstream (S1228), and the intra predictor 542 uses the direction-based intra prediction mode to generate the intra predictor of the current block (S1230).

As described above, the method of generating the combined intra predictor may also be performed by the intra predictor 122 in the video encoding apparatus. The video encoding apparatus may first obtain the combined intra prediction flag, the direction-based intra prediction mode, the matrix-based prediction flag, and the predefined matrix's index, which are set during the rate distortion optimization process, and use them to generate the combined intra predictor of the current block.

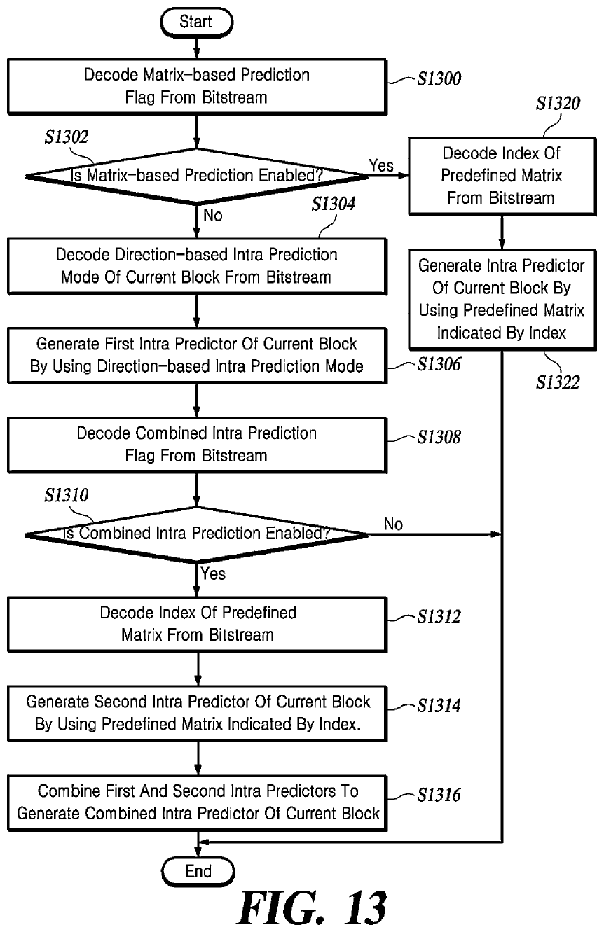

The following describes, using the illustration of FIG. 13, a method performed by the video decoding apparatus for generating a combined intra predictor of the current block when the matrix-based prediction flag is first decoded. Here, the matrix-based prediction flag indicates whether the matrix operation-based prediction is enabled.

FIG. 13 is a flowchart of a method performed by a video decoding apparatus for generating a combined intra predictor, according to another embodiment of the present disclosure.

The entropy decoder 510 in the video decoding apparatus decodes the matrix-based prediction flag from the bitstream (S1300).

The intra predictor 542 in the video decoding apparatus checks the matrix-based prediction flag to determine whether the matrix-based prediction is enabled (S1302).

The foregoing assumes but is not necessarily limited to a case where the matrix operation-based prediction is utilized for generating the second intra predictor of the current block. In other embodiments, other rule-based prediction methods, such as PDPC, may be utilized for generating the second intra predictor of the current block. For example, the video decoding apparatus may decode the position-dependent prediction flag and then use the position-dependent prediction to generate the second intra predictor. Here, the position-dependent prediction flag indicates whether the position-dependent prediction is enabled.

When the matrix-based prediction flag is false, meaning that the matrix-based prediction is not enabled (No in S1302), the video decoding apparatus performs the following steps (Steps S1304 to S1316).

The entropy decoder 510 decodes the direction-based intra prediction mode of the current block from the bitstream (S1304). By decoding the direction-based intra prediction mode, the direction-based prediction may be set as the intra prediction mode of the current block.

The intra predictor 542 uses the direction-based intra prediction mode to generate a first intra predictor of the current block (S1306).

The entropy decoder 510 decodes the combined intra prediction flag from the bitstream (S1308). Here, the combined intra prediction flag indicates whether the combining is enabled between the direction-based intra prediction and the matrix operation-based intra prediction.

The intra predictor 542 checks the combined intra prediction flag to determine whether the combined intra prediction is enabled (S1310).

When the combined intra prediction flag is true, and combined intra prediction is enabled (Yes in S1310), the video decoding apparatus performs the following steps (Steps S1312 to S1316).

The entropy decoder 510 decodes the predefined matrix's index from the bitstream (S1312). By decoding the index indicating one of a plurality of predefined matrices utilized in the matrix operation-based prediction, the matrix operation-based prediction, which is one of the rule-based prediction methods, may be set as the intra prediction mode of the current block.

The intra predictor 542 uses the predefined matrix indicated by the index to generate a second intra predictor of the current block (S1314).

The intra predictor 542 combines the first intra predictor and the second intra predictor to generate a combined intra predictor of the current block (S1316).

When combining the first intra predictor based on the direction-based prediction with the second intra predictor based on the matrix operation-based prediction, the intra predictor 542 may utilize an average or weighted average per the same pixel position for the two predictors.

Here, the average represents the average of the pixels corresponding to the first intra predictor and the pixels corresponding to the second intra predictor for the same pixel location. The weighted average represents a weighted sum of the pixels corresponding to the first intra predictor and the pixels corresponding to the second intra predictor by applying different weight pairs to the pixels. Examples of different weight pairs may be but are not necessarily limited to {¼, ¾}, {⅛, ⅞}, {−¼, 5/4}, {−⅛, 9/8}, etc. Another example may utilize a pair of weights where the sum of the two weights is 1 and the denominator of each weight is a power of 2.

When the combined intra prediction flag is false, meaning that combined intra prediction is not enabled, the intra predictor 542 sets the first intra predictor as the intra predictor of the current block.

On the other hand, when the matrix-based prediction flag is true and matrix-based prediction is enabled (Yes in S1302), the entropy decoder 510 decodes the predefined matrix's index from the bitstream (S1320), and the intra predictor 542 uses the predefined matrix indicated by the index to generate the intra predictor of the current block (S1322).

As described above, the method of generating the combined intra predictor may also be performed by the intra predictor 122 in the video encoding apparatus. The video encoding apparatus may obtain the combined intra prediction flag, the direction-based intra prediction mode, the matrix-based prediction flag, and the predefined matrix's index, which are set during the bit rate distortion optimization process, and use them to generate the combined intra predictor of the current block.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in this specification are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which this disclosure pertains should understand that the scope of the present disclosure is not to be limited by the above explicitly described embodiments but by the claims and equivalents thereof.

### REFERENCE NUMERALS

122: intra predictor
510: entropy decoder
542: intra predictor
910: first intra-prediction mode deriver
920: first intra-predictor generator
930: second intra-prediction mode deriver
940: second intra-predictor generator
950: intra-predictor combiner

What is claimed is:

1. An intra prediction method performed by a video decoding apparatus, the method comprising:
decoding, from a bitstream, a combined intra prediction flag that indicates enablement of combining between a direction-based intra prediction and a matrix operation-based intra prediction; and
performing an intra prediction of the current block according to the combined intra prediction flag,
wherein performing the intra prediction comprises, when the combined intra prediction flag is true:
decoding, from the bitstream, a direction-based intra prediction mode of the current block;
generating a first intra predictor of the current block by using the direction-based intra prediction mode;
decoding, from the bitstream, an index indicating one of a plurality of predefined matrices utilized in the matrix operation-based intra prediction;
generating a second intra predictor of the current block by using a predefined matrix indicated by the index; and
generating a combined intra predictor of the current block by combining the first intra predictor and the second intra predictor.

2. The method of claim 1, wherein generating the first intra predictor comprises generating, from neighboring pixels of the current block, the first intra predictor by using the first intra prediction mode.

3. The method of claim 1, wherein generating the second intra predictor comprises generating, from neighboring pixels of the current block, the second intra predictor by using the predefined matrix.

4. The method of claim 1, wherein generating the combined intra predictor comprises utilizing an average or weighted average per a same pixel position for the first intra predictor and the second intra predictor.

5. The method of claim 1, wherein generating the combined intra predictor comprises applying weights to identical pixel positions of the first intra predictor and the second intra predictor by calculating the weights based on prediction mode information of neighboring blocks that are previously decoded and adjacent to the current block.

6. The method of claim 5, wherein generating the combined intra predictor comprises using one or more left blocks located leftward of the current block and using one or more top blocks located on top of the current block, as the neighboring blocks.

7. The method of claim 6, wherein generating the combined intra predictor comprises:
determining whether only one of an intra prediction mode of the left block and an intra prediction mode of the top block is the direction-based prediction mode, and if yes, setting the weight of the first intra predictor to be equal to the weight of the second intra predictor.

8. The method of claim 6, wherein generating the combined intra predictor comprises:
determining whether an intra prediction mode of the left block and an intra prediction mode of the top block are both the direction-based prediction mode, and if yes, setting the weight of the first intra predictor to be greater than the weight of the second intra predictor, and when the intra prediction mode of the left block and the intra prediction mode of the top block are both the matrix operation-based prediction mode, setting the weight of the second intra predictor to be greater than the weight of the first intra predictor.

9. The method of claim 1, wherein performing the intra prediction comprises, when the combined intra prediction flag is false:
decoding, from the bitstream, a matrix-based prediction flag that indicates whether to enable the matrix operation-based intra prediction;
deriving an intra prediction mode of the current block based on the matrix-based prediction flag; and
generating a third intra predictor of the current block by using the intra prediction mode.

10. The method of claim 9, wherein deriving the intra prediction mode comprises:
decoding, from the bitstream, the index indicating the predefined matrix when the matrix-based prediction flag is true, and decoding, from the bitstream, the direction-based intra prediction mode of the current block when the matrix-based prediction flag is false.

11. The method of claim 10, wherein generating the third intra predictor comprises:
generating an intra predictor of the current block when the matrix-based prediction flag is true by using the predefined matrix indicated by the index, and generating an intra predictor of the current block when the matrix-based prediction flag is false by using the direction-based intra prediction mode.

12. An intra prediction method performed by a video encoding apparatus, the method comprising:
obtaining a combined intra prediction flag that indicates enablement of combining between a direction-based intra prediction and a matrix operation-based intra prediction; and
performing an intra prediction of the current block according to the combined intra prediction flag,
wherein performing the intra prediction comprises, when the combined intra prediction flag is true:
obtaining a direction-based intra prediction mode of the current block;
generating a first intra predictor of the current block by using the direction-based intra prediction mode;
obtaining an index indicating one of a plurality of predefined matrices utilized in the matrix operation-based intra prediction;
generating a second intra predictor of the current block by using a predefined matrix indicated by the index; and
generating a combined intra predictor of the current block by combining the first intra predictor and the second intra predictor.

13. The method of claim 12, wherein generating the combined intra predictor comprises utilizing an average or weighted average per a same position for the first intra predictor and the second intra predictor.

14. The method of claim 12, wherein generating the combined intra predictor comprises applying weights to identical pixel positions of the first intra predictor and the second intra predictor by calculating the weights based on prediction mode information of neighboring blocks that are previously decoded and adjacent to the current block.

15. A computer-readable recording medium storing a bitstream generated by a video encoding method, wherein the method comprising:
obtaining a combined intra prediction flag that indicates enablement of combining between a direction-based intra prediction and a matrix operation-based intra prediction; and
performing an intra prediction of the current block according to the combined intra prediction flag,
wherein performing the intra prediction comprises, when the combined intra prediction flag is true:
obtaining a direction-based intra prediction mode of the current block;
generating a first intra predictor of the current block by using the direction-based intra prediction mode;
obtaining an index indicating one of a plurality of predefined matrices utilized in the matrix operation-based intra prediction;
generating a second intra predictor of the current block by using a predefined matrix indicated by the index; and
generating a combined intra predictor of the current block by combining the first intra predictor and the second intra predictor.
